(19) United States
(12) Patent Application Publication
(10) Pub. No.: US 2015/0101245 A1
(43) Pub. Date: Apr. 16, 2015

(54) SEED COATING COMPOSITIONS

(71) Applicant: Stuart Barclay, Caldwell, ID (US)

(72) Inventor: Stuart Barclay, Caldwell, ID (US)

(21) Appl. No.: 14/277,224

(22) Filed: May 14, 2014

Related U.S. Application Data
(60) Provisional application No. 61/928,097, filed on Jan. 16, 2014.
(60) Provisional application No. 61/891,253, filed on Oct. 15, 2013.

(51) Int. Cl. A01C 1/06

(52) U.S. Cl. CPC A01C 1/06
USPC 47/57.6

(57) ABSTRACT

Disclosed herein are several exemplary seed coating compositions, and exemplary methods for creating and using the same. Also disclosed are several exemplary seed coating manufacturing processes, and the products created by such processes. The seed coating compositions for increasing crop production by protecting coated seeds after planting and during seedling emergence. The seed coating comprising a fungicidally effective amount of at least one zeolite.

### PRIORITY

This application claims the benefit of U.S. Provisional Application Nos. 61/928,097 (filed 16 Jan. 2014) and 61/891,253 (filed 15 Oct. 2013), the disclosures of which are incorporated herein by reference.

### TECHNICAL FIELD

The disclosure generally relates to the field of seed coating for improving the efficiency of plant nutrients.

### SUMMARY OF THE DISCLOSURE

Disclosed herein are several exemplary seed coating compositions, zeolite coated seeds, methods of controlling fungal infections in plants, methods for producing zeolite coated seeds, seed coating (containing zeolites) manufacturing processes, methods of creating seed coating compositions containing zeolite, processes of coating seeds with zeolite, and methods of using zeolite coated seeds using the same. The zeolite seed coating compositions for increasing crop production by protecting coated seeds after planting and during seedling emergence.

A first exemplary coated seed comprises a seed, and a coating on the seed, wherein the coating comprises a fungicidally effective amount of at least one zeolite.

A first exemplary method for producing coated seeds comprises coating seeds with a coating composition, wherein the coating composition comprises a fungicidally effective amount of at least one zeolite.

A first exemplary seed coating composition comprises a fungicidally effective amount of at least one zeolite.

A first exemplary method of controlling fungal infections in plants comprises coating seeds with a seed coating composition comprising a fungicidally effective amount of at least one zeolite before planting.

A first exemplary seed coating manufacturing processes comprises the step of coating a seed with a seed coating composition comprising a fungicidally effective amount of at least one zeolite.

A first exemplary method of creating seed coating compositions comprises the step of coating a seed with a seed coating composition comprising a fungicidally effective amount of at least one zeolite, and a binder component for binding the coating to the seed. The fungicidally effective amount of at least one zeolite can comprise a base of finely ground zeolite.

A first exemplary process of coating seeds, comprises the steps of providing a quantity of seeds, coating the seeds with a quantity of at least one binder component to create coated seeds, applying a quantity of at least one zeolite to said coated seeds, compacting the coated seeds, drying the coated seeds, and screening the dried, coated seeds.

Additional understanding of the compositions, methods, processes and products contemplated and/or claimed by the inventor can be gained by reviewing the detailed description of exemplary devices and methods, presented below.

### DETAILED DESCRIPTION

The following description provides examples of that which the inventor regards as his invention. As such, the embodiments discussed herein are merely exemplary in nature and are not intended to limit the scope of the invention, or its protection, in any manner. Rather, the description of these embodiments serves to enable a person of ordinary skill in the relevant art to practice the invention.

The use of “e.g.,” “etc,” “for instance,” “in example,” “for example,” and “or” and grammatically related terms indicates non-exclusive alternatives without limitation, unless otherwise noted. The use of “including” and grammatically related terms means “including, but not limited to,” unless otherwise noted. The use of the articles “a,” “an,” “the,” and “species” are meant to be interpreted as referring to the singular as well as the plural, unless the context clearly dictates otherwise. Thus, for example, reference to “a zeolite” includes two or more such zeolite species, and the like. The use of “optionally,” “alternatively,” and grammatically related terms means that the subsequently described element, event or circumstance may or may not be present/occur, and that the description includes instances where said element, event or circumstance occurs and instances where it does not. The use of “preferred,” “preferably,” and grammatically related terms means that a specified element or technique is more acceptable than another, but not that such specified element or technique is a necessity, unless the context clearly dictates otherwise. The use of “exemplary” means “an example of” and is not intended to convey a meaning of an ideal or preferred embodiment. Words of approximation (e.g., “substantially,” “generally”), as used in context of the specification and figures, are intended to take on their ordinary and customary meanings which denote approximation, unless the context clearly dictates otherwise.

The use of “zeolite” herein means microporous, aluminosilicate minerals, including all natural and manmade species of zeolites, unless the context clearly dictates otherwise. The zeolite can be in the form of pure compound, technical grade of the compound, or a formulation of the compound. Formulations of the compound can be prepared by admixing the compound with one or more adjuvants including diluents, extenders, carriers, surfactants, and conditioning agents to provide compositions in the form of particulate solids, solutions, dispersions, or emulsions. Such compositions include, for example, wettable powders, granulars, dusts, emulsifiable concentrates, and flowables.

As described in EP1957602B1 (Luke et al.), all zeolites are composed of a three-dimensional framework of SiO₄ and AlO₄ in a tetrahedron, which creates a very high surface area. Cations and water molecules are entrained into that framework. Thus, all zeolites may be represented by the crystallographic unit cell formula:

M_{a/n}[(AlO₂)ₐ(SiO₂)_{b}].xH₂O

where M represents one or more cations such as Na, K, Mg, Ca, Sr, Li or Ba for natural zeolites, and NH₄, CH₃NH₃, (CH₃)₃NH, (CH₃)₄N, Ga, Ge and P for manmade zeolites; n represents the cation valence; the ratio of b:a is in a range from greater than or equal to 1 and less than or equal to 5; and x represents the moles of water entrained into the zeolite framework.

The use of “fungicidally effective amount of zeolite” means the quantity of compound which provides a desired level of fungal disease control in a plant grown from a coated seed, unless the context clearly dictates otherwise. The fungicidally effective amount of zeolite can vary for the various exemplary seed coating compositions depending upon the zeolite species used. A fungicidally effective amount of zeolite will also vary according to the prevailing conditions such as desired fungicidal effect and duration, weather, target species, locus, mode of application, and the like.

The use of “seed coat” means the outer protective covering (“pericarp”) of a seed, unless the context clearly dictates otherwise.

The use of “seed coating process” means any process that results in a compound and a seed being brought together in such a way as to provide reasonably continuous contact between the compound and at least a portion of the seed during the storage, transporting, and planting of the seed, unless the context clearly dictates otherwise. Many seed coating processes are known in the prior art, including but not limited to, true seed coating, seed pelleting, and film coating. A significant number of agronomic, vegetable, and flower seeds are either coated, pelleted, or film coated today for diverse objectives.

Seed pelleting is the deposition of at least one layer of an inert material onto at least a portion of the seed, so as to substantially increase the weight of the seed, and to improve the plantability of the seed. The main application of seed pelleting is to pelletize seeds that are hard to singulate (e.g., small, light, variably-sized, and/or irregularly-shaped seeds) into spherical, or near-spherical, capsules configured for precision sowing. Instead of oversowing raw, uncoated seed, and then subsequently thinning established plants, which can be very costly when seeds and labor are expensive, pelleted seeds can be precisely planted to achieve uniform spacing. Due to their high operational cost, seed pelleting processes are mainly used in the vegetable and flower seed sectors.

Film coating is the application of a continuous layer of a film, such as a polymer film, over at least a portion of a seed to control product dust-off. Film coating is also used for seed cosmetics and variety identification (e.g., by color). Film coating is mainly applied on vegetable seeds, because the high cost of the film coating polymer does not justify its value on low value seeds.

True seed coating may be defined as the addition of at least one layer of a material or materials that would result in a significant increase in seed weight, and/or size increase to at least a portion of the seed, but where the coated seed still retains the same shape as the raw. True seed coating is mainly employed to coat small-seeded, forage legume seeds, and grass seeds. The main purposes of true seed coating are to improve seed plantability, and to incorporate seed treatment chemicals, nutrients, and beneficial elements into the seed coating so as to meet the seedlings' early needs. Moreover, true seed coating has been proven to be the most efficient way of inoculating small-seeded, forage legume seeds.

Seed coatings have been used as means for protecting and enhancing the environment next to the natural seed coat, to control seed germination and/or improve seedling survival and growth rate. Toward these ends, coatings have been used as carriers for a variety of components: agrochemicals, Rhizobium bacteria, nutrients, beneficial elements, and plant growth regulators. Such components can be effective in improving seed germination and seedling survival and growth in the face of diseases, insects, low soil pH, and poor soil fertility. By including these components in seed coatings or pellets, the components are placed at the interface between seed and soil. This close proximity to the interface between seed and soil maximizes the effect of the components and reduces waste and environmental impact compared to the method of broadcasting such components over a field containing uncoated seeds.

The term “hydrophilic additive” means an additive having hydrophilic properties, unless the context clearly dictates otherwise. Examples of hydrophilic additives include, but not limited to, super-hydrating polymers, bentonite and calcium carbonate.

Disclosed herein are several exemplary seed coating compositions, and exemplary methods for creating and using the same. Also disclosed herein are several exemplary coated seed manufacturing processes, and the products created by such processes. Also disclosed are several seed coating compositions for coating seeds.

A first exemplary seed coating composition comprises a seed coating on a seed. The seed coating comprising a fungicidally effective amount of at least one zeolite.

In a second exemplary seed coating composition, the composition comprises a seed coating comprising a fungicidally effective amount of at least one zeolite, and at least one binder component for binding the seed coating to the seed. While this is the preferred formula, a skilled artisan will be able to select an appropriate formula for the composition in a exemplary seed coating composition based on various considerations, including the intended use of the composition, the intended seed type(s) with which the composition will be used, the intended environment within which the composition will be used, and the equipment and/or accessories with which the composition is intended to be used, among other considerations.

In a third exemplary seed coating composition, the coating is from 8 wt % to 500 wt % of the weight of the seed.

In a fourth exemplary seed coating composition, the seed is alfalfa seed, and the coating is from 8 wt % to 50 wt % of the weight of the seed.

In a fifth exemplary seed coating composition, the seed is alfalfa seed, and the coating is about 34 wt % of the coated seed weight.

In a sixth exemplary seed coating composition, the coating on the seeds is about 98 percent by weight (weight percent (wt %)) of said at least one zeolite and about 2 wt % of said at least one binder component.

In a seventh exemplary seed coating composition, the coating on the seed ranges from about 90-99 wt % of said at least one zeolite, about 1-10 wt % of said at least one binder component, and about 0.1-9 wt % of at least one additive component.

In an eighth exemplary seed coating composition, the coating on the seeds is 100 wt % of said at least one zeolite and 0 wt % of said at least one binder component.

In a ninth exemplary seed coating composition, the coating on the seed ranges from about 90-99 wt % of said at least one zeolite and bentonite, about 1-10 wt % of said at least one binder component, and about 0.1-9 wt % of at least one additive component.

In a tenth exemplary seed coating composition, the coating on the seed ranges from about 90-99 wt % of said at least one zeolite and limestone, about 1-10 wt % of said at least one binder component, and about 0.1-9 wt % of at least one additive component.

In an eleventh exemplary seed coating composition, the coating on the seed ranges from about 90-99 wt % of said at least one zeolite, bentonite, and limestone, about 1-10 wt % of at least one binder component, and about 0.1-9 wt % of at least one additive component.

In exemplary seed coating compositions, the binder component can be added to seeds that have already been coated with the at least one zeolite, the binder component can be added to the seeds before they are coated with the at least one zeolite, and/or the binder component and the zeolite can be mixed together before coating of the seeds with the mixture thereof.

In exemplary seed coating compositions, any suitable binder component may be used, including but not limited to binder components selected from the group consisting of water soluble adhesives, polyvinyl alcohol, polyvinyl acetate, Arabic gums, polyvinyl pyrrolidone, calcium lignosulfanate, and synthetic organic polymers.

The binder component is for ensuring that the zeolite binds to the seed coat and remains bound to the seed coat during the compaction process. A suitable binder component should not impair seed germination, should give the seeds a durable coating when the seeds are dry, and should be readily soluble in water so that the coating will not stick on the seed coat when the seeds are wet. Exemplary binders include, but are not limited to, adhesives, binders, glues and stickers. Where the binder component is at least one adhesive, it is preferred that the adhesive be water-soluble. Suitable adhesives include, but are not limited to, polyvinyl alcohol, polyvinyl acetate, Arabic gums, polyvinyl pyrrolidone, calcium lignosulfanate, and synthetic organic polymers.

Exemplary seed coating compositions comprise a mixture of zeolite and a binder component. In other exemplary seed coating compositions, one or more additive components can be added to the composition.

As used herein, the term “additive component” means any additional material or component which is added to a seed coating composition formulation, including but not limited to Rhizobium bacteria, nutrient components, pesticide components, fungicide components, herbicide components, buffers, biologicals to protect a developing seedling (e.g., super-hydrating polymers for keeping the seed coating close to the seed when the seed hydrates, hydroscopic additives for keeping the seed coating close to the seed when the seed hydrates), fillers, and hydroscopic additives, agrochemicals, beneficial elements, and plant growth regulators, unless the context clearly indicates otherwise.

Any suitable nutrient component may be used, including but not limited to nutrients selected from the group consisting of nitrogen (N), phosphorus (P), potassium (K), calcium (Ca), magnesium (Mg), sulfur (S), boron (B), copper (Cu), iron (Fe), chloride (Cl), manganese (Mn), molybdenum (Mo), and Zinc (Zn).

Any suitable pesticide component may be used, including but not limited to pesticides selected from the group consisting of organophosphate pesticides, carbamate pesticides, organochlorine insecticides, pyrethoid pesticides, and microbial pesticides.

Any suitable fungicide component may be used, including but not limited to systemic fungicides and fungicides selected from the group consisting of mancozb, tricyclazole, carbendazim, hexaconazole, metalaxyl, benomyl, difenoconazole, propinconazole, kitazin, tebuconazole, copper oxychloride, copper hydroxide, tridemorph and propineb.

Any suitable herbicide component may be used, including but not limited to fungicides selected from the group consisting of phenoxy acid, benzoic acid, dinitroaniline, bipyridylium, substituted urea, and arsenical.

One example of a filler that can be utilized in exemplary seed coating compositions is calcium carbonate (limestone). Calcium carbonate could also be utilized as a pH buffer. In some exemplary seed coating compositions, the zeolite could be mixed into a quantity of calcium carbonate before application to the seeds or otherwise being incorporated into the seed coating. An additional filler that can be utilized in exemplary seed coating compositions is bentonite. In some exemplary seed coating compositions, bentonite can be added to zeolite and/or calcium carbonate (limestone), as a filler, to alter water absorption of the seed.

Again, as discussed above, exemplary seed coating compositions can further comprise at least one additive component. In a twelfth exemplary seed coating composition, the coating comprises a fungicidally effective amount of at least one zeolite and at least one nutrient component, such as nitrogen.

In an thirteenth exemplary seed coating composition, the coating comprises a fungicidally effective amount of at least one zeolite and at least one pesticide component.

In a fourteenth exemplary seed coating composition, the coating comprises a fungicidally effective amount of at least one zeolite and at least one herbicide.

In a fifteenth exemplary seed coating composition, the coating comprises a fungicidally effective amount of at least one zeolite and an inoculation with Rhizobium bacteria.

In an sixteenth exemplary seed coating composition, the coating comprises a fungicidally effective amount of at least one zeolite and at least one super-hydrating polymer for keeping the seed coating close to the seed when the seed hydrates, thereby holding the seed coating in concentration until the seed breaks dormancy.

In a seventeenth exemplary seed coating composition, the coating comprises a fungicidally effective amount of at least one zeolite and at least one hydroscopic additive for keeping the seed coating close to the seed when the seed hydrates, thereby holding the seed coating in concentration until the seed breaks dormancy.

In an eighteenth exemplary seed coating composition, the coating comprises a fungicidally effective amount of zeolite mixed with calcium carbonate (limestone). In a fourteenth exemplary seed coating composition, the coating comprises a fungicidally effective amount of zeolite mixed with both calcium carbonate (limestone) and bentonite.

A first exemplary method of using a seed coating composition comprises coating a seed with a seed coating composition comprising a fungicidally effective amount of at least one zeolite.

A second exemplary method of using a seed coating composition comprises coating a seed with a seed coating composition comprising a fungicidally effective amount of at least one zeolite and a binder component.

A first exemplary seed manufacturing process comprises coating a seed with a fungicidally effective amount of at least one zeolite.

A second exemplary seed manufacturing process comprises coating a seed with a fungicidally effective amount of at least one zeolite and a binder component.

A second exemplary method for producing seed comprises coating seeds with a fungicidally effective amount of at least one zeolite and a binder component.

A third exemplary method for producing seeds comprises coating seeds with a fungicidally effective amount of at least one zeolite and a binder component, wherein the coating on the seeds ranges from about 90-98 percent by weight (weight percent (wt %)) of said at least one zeolite, about 2 wt % of said at least one binder component, and about 0.1-8 wt % of at least one additive component. While this is the preferred formula, a skilled artisan will be able to select an appropriate formula for the composition in a exemplary method for producing seed based on various considerations, including the intended use of the seed, the intended seed type(s) with will be used, the intended environment within which the seed will be used, and the equipment and/or accessories with which the seed is intended to be used, among other considerations.

A fourth exemplary method for producing seeds comprises coating seeds with a fungicidally effective amount of at least one zeolite and calcium carbonate (limestone) and a binder component, wherein the coating on the seeds ranges from about 90-98 wt % of said at least one zeolite and calcium carbonate (limestone), about 2 wt % of said at least one binder component, and about 0.1-8 wt % of at least one additive component.

A fifth exemplary method for producing seeds comprises coating seeds with a fungicidally effective amount of at least one zeolite and bentonite and a binder component, wherein the coating on the seeds ranges from about 90-98 wt % of said at least one zeolite and bentonite, about 2 wt % of said at least one binder component, and about 0.1-8 wt % of at least one additive component.

A sixth exemplary method for producing seeds comprises coating seeds with a fungicidally effective amount of at least one zeolite, calcium carbonate (limestone), and bentonite and a binder component, wherein the coating on the seeds ranges from about 90-98 wt % of said at least one zeolite, calcium carbonate (limestone), and bentonite, about 2 wt % of said at least one binder component, and about 0.1-8 wt % of at least one additive component.

In a seventh exemplary method for producing seed, the coating is from 8 wt % to 500 wt % of the weight of the seed.

In an eighth exemplary method for producing seed, the seed is alfalfa seed, and the coating is from 8 wt % to 50 wt % of the weight of the seed.

In a ninth exemplary method for producing seed, the seed is alfalfa seed, and the coating is about 34 wt % of the coated seed weight.

Disclosed is utilizing zeolite for controlling fungal infections in plants, specifically by coating plant seeds with zeolite before they are planted. Disclosed is utilizing zeolite for controlling fungal infections in alfalfa, specifically by coating alfalfa seeds with zeolite before they are planted. Disclosed is also using compositions disclosed herein for controlling harmful fungi.

In exemplary seed coating compositions, the at least one zeolite is present in a fungicidally effective amount.

It is preferred that when a coated seed is planted, soil moisture dissolves the seed coating, and the seed is surrounded in a microenvironment, protecting the seed/seedling from soil borne pathogens, including common fungal infections. Common alfalfa fungal infections which exemplary seed coating compositions (use on alfalfa seed) can be used to treat include, but not limited to, Acrocalymma root and crown rot, anthracnose, Aphanomyces root rot, black stem, black patch, black root rot, blossom blight brown root rot, Cercospora leaf spot, charcoal rot, common leaf spot, corky root rot, Cylindrocarpon root rot, Cylindrocladium root and crown rot, common leaf spot, crown bud rot, crown and root rot complex, crown and root rot complex caused by Pythium spp., crown wart, damping-off, damping-off caused by Pythium spp., downy mildew, Fusarium wilt, gray leaf spot, Marasmius root rot, Mycoleptodiscus crown and root rot, Myrothecium root rot, pepper spot (Lepto leaf spot), Phymatotrichum root rot (cotton root rot, Texas root rot), Phytophthora root rot, powdery mildew, Rhizopus sprout rot, rust, Sclerotinia crown and stem rot, Southern blight, spring black stem and leaf spot, Stagonospora leaf spot and root rot, Stemphylium leaf spot, summer black stem and leaf spot, Verticillium wilt, violet root rot, winter crown rot/cottony snow mold, and yellow leaf blotch.

The amount of coating build-up on the seed coat can vary from 8 to 500 wt % of the original, uncoated seed. The preferred range is 8 to 50 wt % for alfalfa seed, measured against the total weight of the seed plus the coating. Higher percentages may be desirable on very light seed. A first exemplary coating on alfalfa seed is about 34 wt % of the coated seed weight, and the coating is preferably about 90-98 wt % of at least one zeolite, about 2 wt % of the at least one binder component, and 0.1-8 wt % of at least one additive component.

A second exemplary process of seed coating utilizes two phases, a wet phase and a dry phase. In the wet phase of coating, a liquid binder component is introduced to the seed in sufficient quantity to adhere to the seed coat an amount of zeolite that is preferably up to twice the weight of the seed. After coating the seed with at least one binder component, finely ground zeolite is introduced to the mixture, and the mixture is further mixed. The resulting mixture is then transferred to a processing line for the compacting of the coated seed, and to start the dry phase. The wet mixture is rolled within an inclined “rolling” drum, to compact the coating on the seed. Compaction, or another process preventing dusting off, is utilized so that the zeolite will not dust off in the bag. Dusting off can result in a multitude of problems, including the clogging of seed drills. After mixing, the coated seed is dried. A heated fluid bed drier, or other drying apparatus/process, can be utilized in this step. The binder component hardens during the drying process, ensuring a durable coating. To arrive at a uniform product after drying, the dried seed is screened to remove any remaining dust that did not adhere to the seed coat, and any agglomerated seeds or coating material. After screening, the coated seed is then bagged for shipment and sales.

In a third exemplary process of seed coating, one or more Rotostat emulsifiers are used. The Rotostat emulsifiers incorporate a rotating pan at the bottom of a vertical cylinder. The pan throws the seed against the inside wall of the cylinder, and as the seed rolls around the wall, atomized binder component is applied from a spinning disk in the center of the cylinder. After coating the seed with the binder component, finely ground zeolite is the applied, for instance, by a hopper located above the cylinder, and the mixture is further mixed. As the seed rolls around the inside wall of the cylinder, the coating is packed on the seed. Compaction, or another process preventing dusting off, is utilized so that the zeolite will not dust off in the bag. Dusting off can result in a multitude of problems, including the clogging of seed drills. After mixing, the cylinders drop the coated seeds into a surge hopper with a belt on the bottom, conveying the seeds to a series of fluid bed dryers, or other drying apparatus/process, with individually controlled temperatures wherein the coated seeds are dried. The binder component hardens during the drying process, ensuring a durable coating on the seeds. To arrive at a uniform product after drying, the dried seeds are screened to remove any remaining dust that did not adhere to the seed, and to remove any agglomerated seeds or coating material. After screening, the coated seeds are then bagged for shipment and sales.

While rolling drum mixers and Rotostat emulsifiers are mentioned above, a skilled artisan will be able to select appropriate equipment used in a process according to a particular embodiment based on various considerations, including the environment within which the coated seed is intended to be used, and the components of the coated seeds. Materials, equipment and processes hereinafter discovered and/or developed that are determined to be suitable for use in creating coated seeds would also be considered suitable for use in an exemplary process.

Through testing by the Applicant, zeolite has shown significant control of Aphanomyces, which APRON® fungicide is unable to do. Through further testing by the Applicant, zeolite has been shown to have an equal to greater effect on Phytopthera (plant-damaging Oomycetes) for which APRON® fungicide is widely used for control. Further testing by the Applicant has shown that zeolite appears to control Pythium better than APRON® fungicide does.

Zeolite is listed under the USDA's National Organic Plan as suitable for use in organic products. Thus, zeolite will be able to be listed as suitable for application to organic seed, affording the organic farming sector with an organic fungicide. Additionally, Zeolite can replace APRON® as a non-chemical control of plant pathogens, giving it an advantageous property for application to conventional and organic seeds.

It is noted that all formulas and compositions of the various described embodiments can be combined in any suitable configuration for inclusion in a seed coating according to a particular embodiment. For example, a seed coating according a particular embodiment can include neither, one, or both of a binder and the additives described above.

Any suitable compounds can be used to form the various components of the seed coating, and a skilled artisan will be able to select appropriate materials for a seed coating according to a particular embodiment based on various considerations, including the intended seed type(s) with which the composition will be used, the intended environment within which the composition will be used, and the equipment and/or accessories with which the composition is intended to be used. Materials hereinafter discovered and/or developed that are determined to be suitable for use in seed coating compositions would also be considered suitable for use in a seed coating composition according to a particular embodiment.

The foregoing detailed description provides exemplary embodiments of the invention and includes the best mode for practicing the invention. The description and illustration of these embodiments is intended only to provide examples of the invention, and not to limit the scope of the invention, or its protection, in any manner.

What is claimed is:

1. A coated seed comprising:
a seed, and
a coating on said seed, wherein said coating comprises a fungicidally effective amount of at least one zeolite.

2. The coated seed of claim 1, wherein said coating further comprises at least one binder component for binding the coating to the seed.

3. The coated seed of claim 2, wherein the coating comprises about 90 to about 98 wt % of said at least one zeolite, about 2 wt % of said at least one binder component, and 0.1-8 wt % of at least one additive component.

4. The coated seed of claim 2, wherein said binder component comprises a water soluble adhesive.

5. The coated seed of claim 4, wherein said binder component is selected from the group consisting of polyvinyl alcohol, polyvinyl acetate, Arabic gums, polyvinyl pyrrolidone, calcium lignosulfanate, and synthetic organic polymers.

6. The coated seed of claim 2, wherein said coating further comprises at least one nutrient component.

7. The coated seed of claim 2, wherein said coating further comprises at least one pesticide component.

8. The coated seed of claim 2, wherein said coating further comprises at least one herbicide component.

9. The coated seed of claim 2, wherein said coating is from 8 wt % to 500 wt % of the weight of the seed.

10. The coated seed of claim 2, wherein said seed is alfalfa seed, and wherein said coating is from 8 wt % to 50 wt % of the weight of the seed.

11. The coated seed of claim 2, wherein said seed is alfalfa seed, and wherein said coating is about 34 wt % of the coated seed weight.

12. The coated seed of claim 2, wherein said coating further comprises an inoculation with Rhizobium bacteria.

13. A coated seed comprising:
an alfalfa seed, and a coating on said alfalfa seed, wherein said coating comprises a fungicidally effective amount of at least one zeolite and binder component for binding the coating to the seed, said binder component comprising at least one water soluble adhesive; wherein the coating is about 98 wt % of said at least one zeolite, and about 2 wt % of said at least one binder component, and wherein said coating is from 8 wt % to 500 wt % of the weight of the seed.

14. A method of controlling fungal infections in plants, comprising the steps of:
providing a quantity of seeds;
coating said seeds with a fungicidally effective amount of at least one zeolite, and at least one binder component to create coated seeds;
compacting the coating seeds;
drying the coated seeds; and
screening the dried, coated seeds.

15. The method of claim 14, wherein said seeds are alfalfa seeds.

16. The method of claim 14, wherein said coating is about 98 wt % of said at least one zeolite, and about 2 wt % of said at least one binder component.

17. The method of claim 14, wherein said binder component comprises a water soluble adhesive.

18. The method of claim 14, wherein said coating is from 8 wt % to 500 wt % of the weight of the seed.

19. The method of claim 14, wherein said coating is about 98 wt % of said at least one zeolite, and about 2 wt % of said at least one binder component, and wherein said coating is from 8 wt % to 500 wt % of the weight of the seed.

20. The method of claim 19, wherein said binder component comprises a water soluble adhesive.
